(19) United States
(12) Patent Application Publication
(10) Pub. No.: US 2024/0429461 A1
(43) Pub. Date: Dec. 26, 2024

(54) PRESSING APPARATUS OF BATTERY CELL

(71) Applicant: SK On Co., Ltd., Seoul (KR)

(72) Inventors: Sung Kyung KIM, Daejeon (KR); Jaechan Ryu, Daejeon (KR)

(21) Appl. No.: 18/744,701

(22) Filed: Jun. 17, 2024

(30) Foreign Application Priority Data
Jun. 20, 2023 (KR) 10-2023-0078971

(51) Int. Cl. H01M 10/42; G01L 1/24

(52) U.S. Cl. CPC H01M 10/4228; G01L 1/24

(57) ABSTRACT

Provided is a pressing apparatus for a battery cell, the apparatus including: a first plate and a third plate spaced apart from each other by a predetermined distance; a second plate movably disposed between the first plate and the third plate; and a pressure indicator changing color based on a pressure change in the battery cell disposed between the second plate and the third plate, wherein the battery cell is disposed between the pressure indicator and the third plate, and the color change of the pressure indicator is visually determined from above the first plate.

### CROSS-REFERENCE TO RELATED APPLICATION(S)

This application claims benefit of priority to Korean Patent Application No. 10-2023-0078971 filed on Jun. 20, 2023 in the Korean Intellectual Property Office, the disclosure of which is incorporated herein by reference in its entirety.

### BACKGROUND

### 1. Field

The present disclosure relates to a pressing apparatus for a battery cell.

### 2. Description of Related Art

In recent years, a high-output battery has been widely used in accordance with the rapid development of industries such as electronics and communications.

Most currently commercialized lithium secondary batteries may use an organic liquid electrolyte in which a lithium salt is dissolved in a flammable organic solvent, and thus have a potential risk of leakage, ignition, and explosion.

Therefore, the development of an all-solid-state battery is in progress, the all-solid-state battery using a solid electrolyte instead of the liquid electrolyte. The all-solid-state battery includes no flammable organic solvent, and a safety device thereof may thus be simplified, leading to research and development conducted in various directions.

As the all-solid-state battery has been developed, there is a need also for a test device measuring a state where the all-solid-state battery is pressed. However, most of the prior battery cell test devices are devices for the lithium secondary battery using the electrolyte. Therefore, there is a need for a measuring device optimized for an all-solid-state battery cell.

### SUMMARY

An aspect of the present disclosure may provide a pressing apparatus for a battery cell that is suitable for measuring an all-solid-state battery cell.

According to an aspect of the present disclosure, provided is a pressing apparatus for a battery cell, the apparatus including: a first plate and a third plate spaced apart from each other by a predetermined distance; a second plate movably disposed between the first plate and the third plate; and a pressure indicator changing color based on a pressure change in the battery cell disposed between the second plate and the third plate, wherein the battery cell is disposed between the pressure indicator and the third plate, and the color change of the pressure indicator is visually determined from above the first plate.

The first plate or the second plate may be at least partially formed of a transparent material.

The apparatus may further include: a plurality of fastening members respectively having one ends fixed and fastened to the third plate, and the other end protruding above the first plate; and a stopper coupled to a portion of the fastening member protruding above the first plate, wherein the second plate is movable in a longitudinal direction of the plurality of fastening members.

The apparatus may further include an elastic member disposed between the first plate and the second plate, and pressing the second plate to the battery cell using an elastic restoring force.

The second plate may have an insertion groove formed in its lower surface, and the pressure indicator may be inserted into the insertion groove.

The apparatus may further include a pressure distribution member disposed between the pressure indicator and the battery cell to distribute a pressure applied to the pressure indicator.

The pressure distribution member may have a flat pad shape, and include any one of rubber, polyurethane, and silicone.

The apparatus may further include a hydrogen sulfide detection unit disposed between the battery cell and the third plate to detect hydrogen sulfide (H₂S).

The hydrogen sulfide detection unit may include a body part formed in a flat sheet shape, and a discoloration portion coupled to the body part and including an organometallic compound discolored by reacting with hydrogen sulfide.

The body part may be made of a porous material and include polydimethyl siloxane.

According to an aspect of the present disclosure, provided is a pressing apparatus for a battery cell, the apparatus including: a hydrogen sulfide detection unit stacked below the battery cell and detecting hydrogen sulfide leaking from the battery cell; and a pressure indicator stacked above the battery cell and changing color based on a pressure applied from the battery cell, wherein the hydrogen sulfide detection unit includes an organometallic compound discolored by reacting with hydrogen sulfide.

The hydrogen sulfide detection unit may include a porous transparent polydimethyl siloxane pad impregnated with the organometallic compound.

The apparatus may further include a plate stacked above the pressure indicator and moved up and down in response to a volume change in the battery cell, wherein the flat plate is at least partially formed of a transparent material.

According to an aspect of the present disclosure, provided is a pressing apparatus for a battery cell, the apparatus including: a first plate and a third plate spaced apart from each other in a first direction; a second plate movable between the first plate and the third plate in the first direction; and a pressure indicator visually displaying an amount of pressure applied to the battery cell disposed between the second plate and the third plate, wherein the pressure indicator changes its displayed color based on a pressure applied to the battery cell.

The pressure indicator may be disposed between the second plate and the battery cell, and visually determined using the first plate.

### BRIEF DESCRIPTION OF DRAWINGS

The above and other aspects, features, and advantages of the present disclosure will be more clearly understood from the following detailed description taken in conjunction with the accompanying drawings, in which:

FIG. 1 is a perspective view of a pressing apparatus for a battery cell according to an exemplary embodiment of the present disclosure;

FIG. 2 is an exploded perspective view of the pressing apparatus shown in FIG. 1;

FIG. 3 is a side view of the pressing apparatus shown in FIG. 1;

FIG. 4 is a cross-sectional view showing an operation of the pressing apparatus shown in FIG. 3; and

FIG. 5 is a perspective view of a hydrogen sulfide detection unit shown in FIG. 2.

### DETAILED DESCRIPTION

Hereinafter, exemplary embodiments of the present disclosure will now be described in detail with reference to the accompanying drawings.

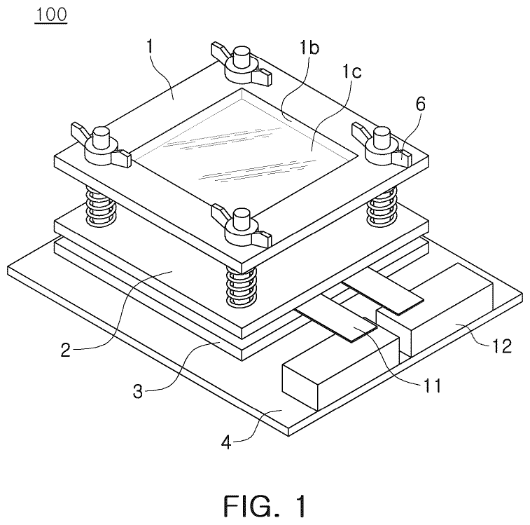

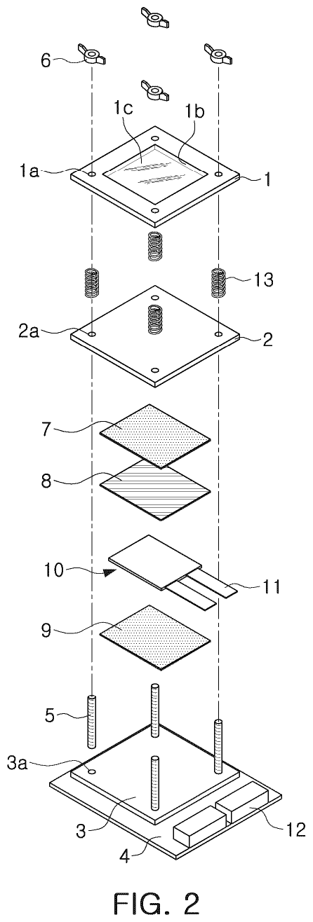

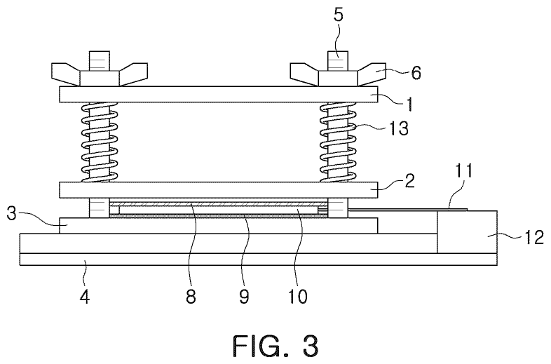

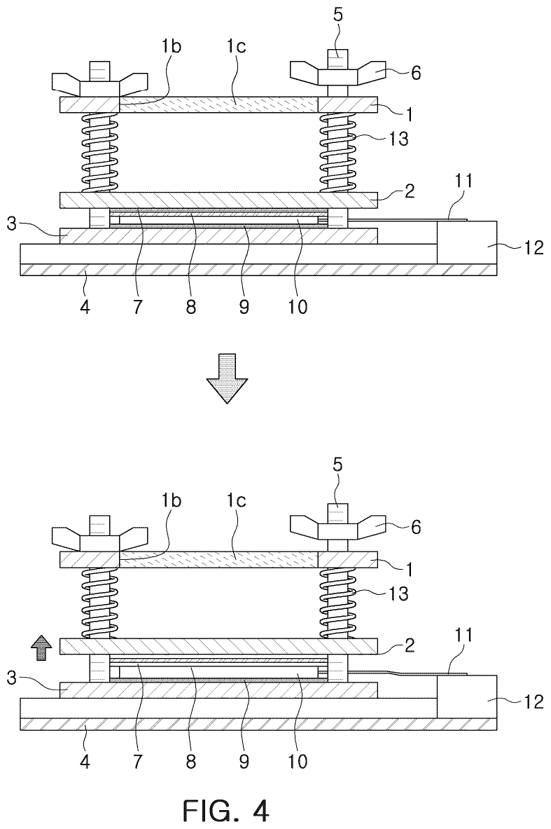

FIG. 1 is a perspective view of a pressing apparatus for a battery cell according to an exemplary embodiment of the present disclosure, and FIG. 2 is an exploded perspective view of the pressing apparatus shown in FIG. 1. In addition, FIG. 3 is a side view of the pressing apparatus shown in FIG. 1, and FIG. 4 is a cross-sectional view showing an operation of the pressing apparatus shown in FIG. 3.

Referring to FIGS. 1 through 4, a pressing apparatus 100 according to an exemplary embodiment of the present disclosure may be an apparatus measuring a pressure change that occurs in a flat object 10 to be measured such as a battery cell, and include a first plate 1 and a third plate 3, which are fixed plates, a second plate 2, which is a movable plate, a pressure indicator 7, and a hydrogen sulfide detection unit 9.

The object 10 to be measured in this exemplary embodiment may include an all-solid-state battery cell.

Meanwhile, in the specification, the all-solid-state battery cell may refer to a battery using an electrolyte other than a liquid electrolyte including a flammable organic solvent.

For example, the all-solid-state battery cell may be a battery using solid electrolyte, a gel-polymer electrolyte, or a composite electrolyte.

In more detail, the hydrogen sulfide detection unit 9 may detect hydrogen sulfide (H₂S) leaking from the object to be detected as described below. Therefore, in the specification, the all-solid-state battery cell may be a battery using a sulfide-based solid electrolyte.

Compared to a lithium-ion battery using the electrolyte, an all-solid-state battery may have increased battery safety and a significantly lower possibility of fire or explosion even when a short circuit occurs. In addition, the all-solid-state battery cell of this exemplary embodiment may include a pouch-type battery cell having a battery cell case formed by an aluminum film or the like.

Each of the first to the third plates 1, 2, and 3 may be a plate having a rigidity enabling the plate not to be bent during a pressure measurement process.

The first to the third plates 1, 2, and 3 may be stacked and arranged to be parallel to one another, and may be spaced apart from one another not to be in contact with one another. In addition, the battery cell, which is the object 10 to be measured, and the pressure indicator 7 may be disposed between the second plate 2 and the third plate 3. That is, the third plate 3 may be disposed below the object 10 to be measured, the second plate 2 may be disposed above the object 10 to be measured, and the first plate 1 may be disposed above the second plate 2.

The first and the second plates 1 and 2 may each have a larger area than that of the object 10 to be measured, and have a plurality of through holes 1a and 2a into which fastening members 5 such as bolts are inserted.

The plurality of through holes 1a and 2a may be disposed in a surrounding region of the object 10 to be measured while being spaced apart from each other, and each of the through holes 1a and 2a may have the same separation distance (e.g., horizontal distance) from the object 10 to be measured.

The third plate 3 may be disposed below the second plate 2, and have the same or similar area as that of the first or second plate 1 or 2. The third plate 3 may have a plurality of fastening grooves 3a to which the fastening members 5 described above are coupled. The plurality of fastening grooves 3a may be disposed in positions corresponding to those of the plurality of through holes 1a and 2a, and a thread may be formed in the fastening groove 3a for its connection with the fastening member 5.

In this exemplary embodiment, the third plate 3 may be coupled to a base 4, and its movement may thus be suppressed. However, a configuration to fix the third plate is not limited thereto, and may be variously modified as long as the configuration stably fixes the third plate 3 thereto.

The fastening member 5 may fix and fasten the first plate 1 and the third plate 3 to each other. For example, the fastening member 5 may have a shape of a rod having no head and having a thread formed on its outer circumference, like a stud bolt, and one end of the fastening member 5 may sequentially pass through the first plate 1 and the second plate 2, and then be screwed into the coupling groove 3a of the third plate 3.

The other end of the fastening member 5 may protrude above the first plate 1 to be coupled with a stopper 6. The stopper 6 may be screw-coupled to the other end of the fastening member 5 to thus prevent the first plate 1 from leaving the fastening member 5. In this exemplary embodiment, the stopper 6 may use a nut or a knob nut, and is not limited thereto.

The second plate 2 may have the plurality of through holes 2a through which the fastening member 5 described above passes. A diameter of the through hole 2a may be larger than a diameter of the fastening member 5, and the second plate 2 may thus be moved up and down between the first plate 1 and the third plate 3 in a longitudinal direction of the fastening member 5.

An elastic member 13 may be disposed between the first plate 1 and the second plate 2. The elastic member 13 may press the second plate 2 to the object 10 to be measured using an elastic restoring force.

In this exemplary embodiment, the elastic member 13 may include a compression spring. For example, the fastening member 5 may pass through the center of the compression spring to be coupled with the compression spring. Accordingly, the elastic member 13 may be compressed in the longitudinal direction of the fastening member 5 and provide the elastic restoring force to the second plate 2.

Through this configuration, the elastic member 13 may be compressed when reducing a distance between the first plate 1 and the second plate 2 to thus increase the elastic restoring force of the elastic member 13, thereby also increasing the pressure applied by the second plate 2 to the object 10 to be measured. Therefore, the pressure applied to the object 10 to be measured may be adjusted by adjusting the distance between the first plate 1 and the second plate 2.

The pressure indicator 7 may be disposed above the object 10 to be measured. In detail, the pressure indicator 7 may be disposed between the second plate 2 and the object to be measured. The pressure indicator 7 may measure a pressure applied to the pressure indicator 7 due to a volume expansion of the object 10 to be measured.

The pressure indicator 7 according to this exemplary embodiment may include a sheet-type pressure sensor, and change its color in response to the pressure applied thereto. For example, the pressure indicator 7 may include a piezoelectric material that changes its color based on the pressure applied thereto, and thus visually display an amount of pressure applied to the object 10 to be measured.

The color change of the pressure indicator 7 may be achieved by doping dopants having different color light output features into the piezoelectric material, and is not limited thereto.

The pressure indicator 7 may have an area facing the entire one surface of the object 10 to be measured. In addition, at least a portion of the pressure indicator 7 in this exemplary embodiment may be inserted into the second plate 2. To this end, the second plate 2 may have an insertion groove 2b which is formed in its lower surface and into which the pressure indicator 7 is inserted.

A depth of the insertion groove 2b may be the same as a thickness of the pressure indicator 7. Therefore, a lower surface of the pressure indicator 7 may be disposed on the same plane as the lower surface of the second plate 2.

Meanwhile, as described above, the pressure indicator 7 in this exemplary embodiment may display the amount of pressure through its color change. Therefore, the pressure indicator 7 in this exemplary embodiment may be required to be visually determined from the outside of the pressing apparatus 100.

To this end, the first plate 1 or the second plate 2 of this exemplary embodiment may be at least partially formed of a transparent material.

The first plate 1 in this exemplary embodiment may include an identification region S formed in its region corresponding to the object 10 to be measured. An operator may visually check the second plate 2 through the identification region S. To this end, the identification region S may have a through hole 1b, or a transparent member 1c coupled to the through hole 1b.

Here, the transparent member 1c may use glass or transparent acrylic, and is not limited thereto.

The entire second plate 2 in this exemplary embodiment may be made of the transparent material. For example, the entire second plate 2 may be made of glass or a transparent acrylic material. Therefore, the pressure indicator 7 disposed below the second plate 2 may be easily identified from above the second plate 2.

Through this configuration, the operator may easily identify the color change of the pressure indicator 7 disposed below the second plate 2 from above the first plate 1.

Meanwhile, in this exemplary embodiment, the first plate 1 may have only some regions as the identification region S, its configuration in the present disclosure is not limited thereto, and like the second plate 2, the entire first plate 1 may be formed as a transparent member to thus form the entire first plate 1 as the identification region. Likewise, the second plate 2 may not be entirely made of transparent material, and the transparent member may be disposed only in some regions like the first plate 1.

The pressing apparatus 100 of this exemplary embodiment may include a pressure distribution member 8 disposed between the object 10 to be measured and the pressure indicator 7. The pressure distribution member 8 may relieve the pressure from being concentrated at a specific location of the pressure indicator 7, may have a flat shape like a pad or a sheet, and may be in contact with the entire one surface of the object 10 to be measured.

The pressure distribution member 8 may include a material compressed and elastically deformed by an external force, such as rubber, polyurethane, or silicone. However, its configuration in the present disclosure is not limited thereto. For example, the pressure distribution member 8 may include transparent polydimethyl siloxane.

The hydrogen sulfide detection unit 9 may be disposed below the object 10 to be measured to detect hydrogen sulfide when hydrogen sulfide leaks from the object 10 to be measured.

The all-solid-state battery cell, which is the object to be measured, may use an inorganic solid electrolyte instead of an organic solvent electrolyte. Among the inorganic solid electrolytes, the sulfide-based solid electrolyte may have ionic conductivity higher than that of an oxide-based solid electrolyte, and thus have many advantages in acquiring a high-performance all-solid-state battery. However, the object 10 to be measured using the sulfide-based solid electrolyte may include sulfur. Therefore, sulfur and moisture permeating into the battery cell may react each other to produce toxic hydrogen sulfide (H₂S). That is, there is a possibility that hydrogen sulfide may leak externally if an exterior material of the all-solid-state battery cell is destroyed.

Therefore, the pressing g apparatus 100 in this exemplary embodiment may include the hydrogen sulfide detection unit 9 to rapidly detect leakage of hydrogen sulfide if hydrogen sulfide leaks during a testing process of the object 10 to be measured.

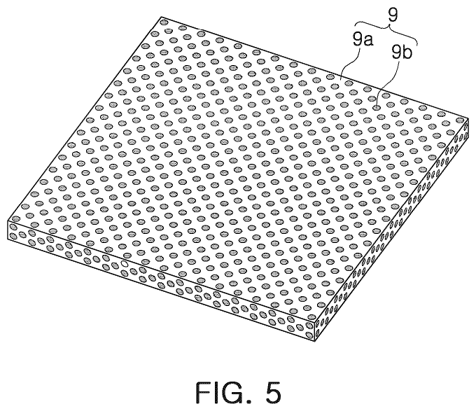

FIG. 5 is a perspective view of the hydrogen sulfide detection unit shown in FIG. 2. Referring to FIGS. 2 and 5 together, the hydrogen sulfide detection unit 9 in this exemplary embodiment may be disposed between the object 10 to be measured and the third plate 3, and include a body part 9a formed in a flat sheet shape, and a discoloration portion 9b coupled to the body part 9a.

The discoloration portion 9b may include a material rapidly discolored by reacting with hydrogen sulfide. TO this end, the discoloration portion 9b in this exemplary embodiment may include an organometallic compound. For example, the discoloration portion 9b may include at least one element selected from the group consisting of copper (Cu), lead (Pb), silver (Ag), manganese (Mn), nickel (Ni), cobalt (Co), tin (Sn), and cadmium (Cd). The element may be required to be easily discolored. In this viewpoint, the element may thus be coupled to the body part 9a in a state where the element is already ionized or susceptible to the ionization. In more detail, the discoloration portion 9b may include at least one selected from the group consisting of copper (II) sulfate (CuSO₄), lead (II) acetate trihydrate (Pb(CH₃COO)₂), and silver sulfate (Ag₂SO₄).

The discoloration portion 9b may be dispersed throughout the body part 9a and may be in a liquid state, a solid state, or a gel state.

The body part 9a may have a plurality of grooves in its surface, and the discoloration portions 9b may fill the grooves. For example, the body part 9a may be made of a porous material having a plurality of holes formed therein, and the discoloration portions 9b may fill the holes and the external grooves.

For example, the body part 9a may be made of a silicone material. In detail, the body part 9a may include polydimethyl siloxane. In this case, the body part 9a may be compressed by the external force to be elastically deformed. Therefore, like the pressure distribution member 8 described above, the body part 9a may also distribute the pressure applied to the object 10 to be measured.

In addition, for easy identification of the discoloration portion 9b, the body part 9a may be made of the transparent material. However, its configuration in the present disclosure is not limited thereto, and the body part 9a may be made of various materials as long as the discoloration portion 9b is easily coupled thereto and easily identified. The hydrogen sulfide detection unit 9 in this exemplary embodiment configured in this way may be formed by impregnating the body part 9a into an impregnating solution including the discoloration portion 9b, and is not limited thereto.

Meanwhile, a voltage supply unit 12 may be disposed on the base 4, the voltage supply unit 12 being connected to an external electrode 11 of the object 10 to be measured and supplying a voltage to the object 10 to be measured. Each voltage supply unit 12 may be disposed at a location corresponding to that of the external electrode 11 of the object 10 to be measured, is not limited thereto, and may be disposed in various locations while having various forms as long as the voltage supply unit 12 is electrically connected to the external electrode 11 and is capable of charging or discharging the object 10 to be measured.

Next, referring to FIG. 4, the description descries the operation of the pressing apparatus 100 according to this exemplary embodiment.

First, the battery cell, which is the object 10 to be measured, may be disposed between the second plate 2 and the third plate 3, and the pressing apparatus 100 may adjust the pressure at which the second plate 2 presses the object to be measured using the fastening member 5 and the stopper 6.

Next, the pressing apparatus 100 may apply the voltage to the object 10 to be measured and repeatedly charge and discharge the object 10 to be measured.

When the volume of the object 10 to be measured expands due to the repeated charging and discharging, the second plate 2 and the third plate 3 may be pressed by the expanded object 10 to be measured. Here, the third plate 3 may not be moved by being fixed to the base 4, and the object to be measured may thus support the third plate 3 and press the second plate 2. The pressure indicator 7 may be disposed between the object 10 to be measured and the second plate 2. Therefore, the pressure changed by the expansion of the object 10 to be measured may be applied to the pressure indicator 7. Accordingly, the pressure indicator 7 may change its color based on the pressure change in the object to be measured.

In this process, the pressure may be applied to one surface of the second plate 2 due to the elastic restoring force of the elastic member 13, and the pressure may be applied to the other surface of the second plate 2 due to the expansion of the object 10 to be measured. Therefore, the pressure applied to the second plate 2 may become greater than the elastic restoring force of the elastic member 13 due to the volume change of the object 10 to be measured. In this case, the second plate 2 may be moved to be closer to the first plate 1. That is, when the volume of the object to be measured excessively expands, a distance between the second plate 2 and the third plate 3 may expand in response thereto.

As described above, the pressure indicator 7 in this exemplary embodiment may change its color in response to the pressure applied thereto. Therefore, the operator may visually check the pressure change caused by the expansion of the object 10 to be measured using the color change of the pressure indicator 7. In addition, the pressure indicator 7 in this exemplary embodiment may also enable a local pressure change check because only a corresponding part of the pressure indicator 7 changes its color when the local pressure change occurs in the object 10 to be measured.

In other words, the pressure indicator 7 may externally display the pressure applied to the object 10 to be measured as visual information in color. In addition, the pressure indicator 7 may display the pressure change in the object 10 to be measured as a change in color.

According to an exemplary embodiment, the pressure indicator 7 may be disposed between the second plate 2 and the object 10 to be measured, and may be visually determined using the first plate 1. Through this configuration, the operator may easily recognize the amount and change in pressure applied to the object 10 to be measured.

Meanwhile, the object 10 to be measured in this exemplary embodiment may include the inorganic solid electrolyte. In this case, hydrogen sulfide may leak from the object 10 to be measured when the exterior material of the object 10 to be measured is damaged during the process of pressing the object 10 to be measured. In this case, the pressing apparatus 100 in this exemplary embodiment may detect the leakage of hydrogen sulfide using the hydrogen sulfide detection unit 9 disposed below the object 10 to be measured.

The hydrogen sulfide detection unit 9 may include the discoloration portion 9b discolored by reacting with hydrogen sulfide, the entire discoloration portions 9b being arranged along a perimeter of the object 10 to be measured. Therefore, hydrogen sulfide leaking from the object 10 to be measured may easily come into contact with the discoloration portion 9b, and the operator may thus rapidly check whether the hydrogen sulfide leaks.

The pressing apparatus 100 according to this exemplary embodiment configured as described above may press the object 10 to be measured using the elastic force of the elastic member 13. Therefore, the constant pressure applied to the object 10 to be measured may be maintained during the test process, and when the object 10 to be measured expands, the elastic member 13 may absorb an effect of the volume change in the object 10 to be measured. Accordingly, it is possible to prevent damage to the object 10 to be measured due to the expansion of the object 10 to be measured during the test process.

In addition, in the pressing apparatus in this exemplary embodiment, the pressure indicator 7 may visually display the pressure change through its color change, and the operator may thus visually check this change with ease. Therefore, it is possible to variously analyze the pressure change in the object 10 to be measured.

In addition, it is also possible to early detect abnormalities in the all-solid-state battery cell in the test process because the leakage of hydrogen sulfide may be visually detected by the hydrogen sulfide detection unit 9.

As set forth above, according to the exemplary embodiment of the present disclosure, the pressure indicator may visually display the pressure change through its color change, thus making it possible to variously analyze the pressure change in the object to be measured. In addition, it is also possible to early detect the abnormalities in the all-solid-state battery cell in the test process because the leakage of hydrogen sulfide may be visually detected by the hydrogen sulfide detection unit 9.

While the exemplary embodiments have been shown and described above, it will be apparent to those skilled in the art that modifications and variations could be made without departing from the scope of the present disclosure as defined by the appended claims.

The exemplary embodiment described above takes the case of measuring the all-solid-state battery cell as an example, is not necessarily limited thereto as long as the hydrogen sulfide leak may be visually detected.

What is claimed is:

1. A pressing apparatus for a battery cell, the apparatus comprising:
a first plate and a third plate spaced apart from each other by a predetermined distance;
a second plate movably disposed between the first plate and the third plate; and
a pressure indicator changing color based on a pressure change in the battery cell disposed between the second plate and the third plate,
wherein the battery cell is disposed between the pressure indicator and the third plate, and
the color change of the pressure indicator is visually determined from above the first plate.

2. The apparatus of claim 1, wherein the first plate or the second plate is at least partially formed of a transparent material.

3. The apparatus of claim 1, further comprising:
a plurality of fastening members respectively having one ends fixed and fastened to the third plate, and the other end protruding above the first plate; and
a stopper coupled to a portion of the fastening member protruding above the first plate,
wherein the second plate is movable in a longitudinal direction of the plurality of fastening members.

4. The apparatus of claim 3, further comprising an elastic member disposed between the first plate and the second plate, and pressing the second plate to the battery cell using an elastic restoring force.

5. The apparatus of claim 1, wherein the second plate has an insertion groove formed in its lower surface, and the pressure indicator is inserted into the insertion groove.

6. The apparatus of claim 1, further comprising a pressure distribution member disposed between the pressure indicator and the battery cell to distribute a pressure applied to the pressure indicator.

7. The apparatus of claim 6, wherein the pressure distribution member has a flat pad shape, and includes any one of rubber, polyurethane, and silicone.

8. The apparatus of claim 1, further comprising a hydrogen sulfide detection unit disposed between the battery cell and the third plate to detect hydrogen sulfide (H₂S).

9. The apparatus of claim 8, wherein the hydrogen sulfide detection unit includes
a body part formed in a flat sheet shape, and
a discoloration portion coupled to the body part and including an organometallic compound discolored by reacting with hydrogen sulfide.

10. The apparatus of claim 9, wherein the body part is made of a porous material and includes polydimethyl siloxane.

11. A pressing apparatus for a battery cell, the apparatus comprising:
a hydrogen sulfide detection unit stacked below the battery cell and detecting hydrogen sulfide leaking from the battery cell; and
a pressure indicator stacked above the battery cell and changing color based on a pressure applied from the battery cell,
wherein the hydrogen sulfide detection unit includes an organometallic compound discolored by reacting with hydrogen sulfide.

12. The apparatus of claim 11, wherein the hydrogen sulfide detection unit includes a porous transparent polydimethyl siloxane pad impregnated with the organometallic compound.

13. The apparatus of claim 11, further comprising a plate stacked above the pressure indicator and moved up and down in response to a volume change in the battery cell,
wherein the flat plate is at least partially formed of a transparent material.

14. A pressing apparatus for a battery cell, the apparatus comprising:
a first plate and a third plate spaced apart from each other in a first direction;
a second plate movable between the first plate and the third plate in the first direction; and
a pressure indicator visually displaying an amount of pressure applied to the battery cell disposed between the second plate and the third plate,
wherein the pressure indicator changes its displayed color based on the amount of pressure applied to the battery cell.

15. The apparatus of claim 14, wherein the pressure indicator is disposed between the second plate and the battery cell, and visually determined through the first plate.
